(19) United States
(12) Patent Application Publication
(10) Pub. No.: US 2014/0116955 A1
(43) Pub. Date: May 1, 2014

(54) DISPOSAL OF OIL SAND TAILINGS CENTRIFUGE CAKE

(71) Applicant: SYNCRUDE CANADA, LTD. in trust for the owners of the Syncrude Project as such owners exist now and, Fort McMurray (CA)

(72) Inventors: JAMES LORENTZ, Fort McMurray (CA); RICK LAHAIE, Canmore (CA); RANDY MIKULA, Edmonton (CA); ROBERT DONAHUE, Edmonton (CA); TERRI-LYNN REEB, Calgary (CA); ROBERT CAMERON, Fort McMurray (CA); DANIEL WAYNE MIMURA, Fort McMurray (CA)

(73) Assignee: SYNCRUDE CANADA, LTD. in trust for the owners of the Syncrude Project as such owners exist now and, Fort McMurray (CA)

(21) Appl. No.: 14/013,806

(22) Filed: Aug. 29, 2013

Related U.S. Application Data
(60) Provisional application No. 61/719,338, filed on Oct. 26, 2012.

(51) Int. Cl. C02F 9/00

(52) U.S. Cl. CPC C02F 9/00
USPC 210/710

(57) ABSTRACT

A process for the disposal of oil sands tailings is provided, comprising: optionally diluting the tailings with sufficient water to yield a tailings feed having a solids content in the range of about 18 wt % to about 36 wt %; adding one or both of a coagulant and a flocculant to the tailings feed to form a centrifuge feed; centrifuging the centrifuge feed to produce a centrifuge cake having a solids content of at least about 50% and a centrate having a solids content of less than about 3 wt %; and introducing the centrifuge cake into an overburden containment structure comprised of oil sand overburden, said overburden containment structure comprising a least one trench for holding the centrifuge cake, or into a deep disposal site for additional dewatering of the centrifuge cake through self-weight consolidation and creep.

### FIELD OF THE INVENTION

The present invention relates to a process for disposing centrifuge cakes produced from centrifugation of oil sands tailings, particularly, fluid fine tailings.

### BACKGROUND OF THE INVENTION

Oil sand generally comprises water-wet sand grains held together by a matrix of viscous heavy oil or bitumen. Bitumen is a complex and viscous mixture of large or heavy hydrocarbon molecules which contain a significant amount of sulfur, nitrogen and oxygen. The extraction of bitumen from oil sand using hot water processes yields large volumes of fine tailings composed of fine silts, clays, residual bitumen and water. Mineral fractions with a particle diameter less than 44 microns are referred to as “fines.”

The fine tailings suspension is typically 85% water and 15% fine particles by mass. Dewatering of fine tailings occurs very slowly. When first discharged in ponds, the very low density material is referred to as thin fine tailings. After a few years when the fine tailings have reached a solids content of about 30-35%, they are referred to as fluid fine tailings (FFT) which behave as a fluid-like colloidal material. The fact that fluid fine tailings behave as a fluid and have very slow consolidation rates significantly limits options to reclaim tailings ponds. A challenge facing the industry remains the removal of water from the fluid fine tailings to strengthen the deposits so that they can be reclaimed.

Recently, the present applicant developed a process for dewatering oil sands tailings by treating the tailings with coagulant and flocculant prior to dewatering by centrifugation (see U.S. patent application Ser. No. 13/594,402, incorporated hereto by reference). The centrifugation process is particularly useful with, but not limited to, fluid fine tailings. Dewatering the tailings by centrifugation enables reclamation of tailings disposal areas and recovery of water for recycling. However, one challenge faced by the applicant is disposal of the resultant centrifuge cake. Cake properties are a function of the solids content and water chemistry. It was discovered that the addition of gypsum improved the conveyability of the cake from the centrifuge, which is generally a reflection of the strength of the cake product. Generally, the produced cake from the centrifugation process has a solids content of at least about 50%. Thus, disposal and further drying of the centrifuge cake is required.

### SUMMARY OF THE INVENTION

In one aspect, the current application is directed to a process scheme for depositing centrifuge cakes derived from centrifugation of oil sand tailings using overburden from an oil sand mine site. As used herein, the term “overburden” means a layer of rocky clay-like material which overlies an oil sand deposit. In one embodiment, the overburden comprises consolidated clay-shale material. In one embodiment, the overburden has a moisture content ranging from about 15 wt % to about 25 wt %. In one embodiment, the overburden has a moisture content of about 20 wt %.

In particular, an overburden containment structure is used for storage of the partially dewatered tailings, which tailings are in the form of a centrifuge cake, which allows for further consolidation and dewatering of the centrifuge cake to occur. Thus, in one aspect, a process for the disposal of oil sands tailings is provided, comprising:
optionally diluting the tailings with sufficient water to yield a tailings feed having a solids content in the range of about 18 wt % to about 36 wt %;
adding one or both of a coagulant and a flocculant to the tailings feed to form a centrifuge feed;
centrifuging the centrifuge feed to produce a centrifuge cake having a solids content of at least about 50% and a centrate having a solids content of less than about 3 wt %; and
introducing the centrifuge cake into an overburden containment structure comprised of oil sand overburden, said overburden containment structure comprising a least one trench for holding the centrifuge cake.

In one embodiment, the overburden containment structure comprises a number of trenches, whereby when each trench is filled with centrifuge cakes, additional mined overburden can be placed on top of the trenches to form an overburden cap. In another embodiment, the process further comprises draining water released from the centrifuge cake together with any environmental precipitation.

In another aspect, partially dewatered tailings, which tailings are in the form of a centrifuge cake, which is deposited into a deep cohesive deposit, which generally comprises a mined out or excavated mine pit, where further consolidation and dewatering of the centrifuge cake can occur. Thus, in one aspect, a process for the disposal of oil sands tailings is provided, comprising:
optionally diluting the tailings with sufficient water to yield a tailings feed having a solids content in the range of about 18 wt % to about 36 wt %;
adding one or both of a coagulant and a flocculant to the tailings feed to form a centrifuge feed;
centrifuging the centrifuge feed to produce a centrifuge cake having a solids content of at least about 50% and a centrate having a solids content of less than about 3 wt %; and
depositing the centrifuge cake into a deep disposal site for additional dewatering of the centrifuge cake through self-weight consolidation and creep.

In one embodiment, sand layers are added to enhance dewatering rates. In another embodiment, geo-drains are added to enhance dewatering rates. Thus, an important performance factor is the increase in solids content (or volume reduction) with time. Hence, in one embodiment, the process further comprises draining released water and environmental precipitation from the deep disposal site.

In another embodiment, petroleum coke, for example, coke produced from fluid coking of bitumen, can be used to form a coke cap.

In another aspect, centrifuge cake deposits are subjected to freeze-thaw cycles. The applicant has surprisingly discovered that drainage of the water in a centrifuge cake improves when first frozen and then subjected to thawing. Further, it was discovered that frost penetration depth is increased by actively clearing snow during the winter using blowers, large fans and street sweepers. It is understood that in areas such as Athabasca, Alberta, where oil sands deposits are in abundance, the average temperature during the winter months is about −15° C. and the average monthly snow fall during that time is around 24 cm. It was also discovered that repeatedly track-packing centrifuge cake deposits with dozers will also increase frost thickness.

### BRIEF DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIG. 1 is a flow diagram of an embodiment of a centrifugation process useful in the present invention.

FIG. 2 is a schematic of one embodiment of the present invention which shows an overburden containment structure for depositing centrifuge cakes produced from the centrifugation of oil sands tailings.

FIGS. 3A to D are schematics of one embodiment of the present invention which show a deep disposal site for depositing centrifuge cakes produced from the centrifugation of oil sands tailings over time.

FIGS. 4a, b, c are CT scans of frozen core recovered from FFT deposit (core diameter of 10 cm).

FIG. 5 shows a plot of frozen bulk density versus thaw strain (under zero load) of FFT samples treated with polymer and subjected to thin lift and perimeter ditch deposits (open circles) as compared to FFT treated with gypsum and subjected to centrifugation (closed circles).

FIG. 6 shows freeze thaw evaporative drying experimental results for gypsum and non-gypsum centrifuge cake, with and without drainage.

### DETAILED DESCRIPTION OF THE PREFERRED EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

The present invention relates generally to a process for disposing of centrifugation cakes derived from centrifugation of the tailings. As used herein, the term “tailings” means tailings derived from oil sands extraction operations and containing a fines fraction. The term is meant to include fluid fine tailings (FFT) from tailings ponds and fine tailings from ongoing extraction operations (for example, thickener underflow or froth treatment tailings) which may bypass a tailings pond.

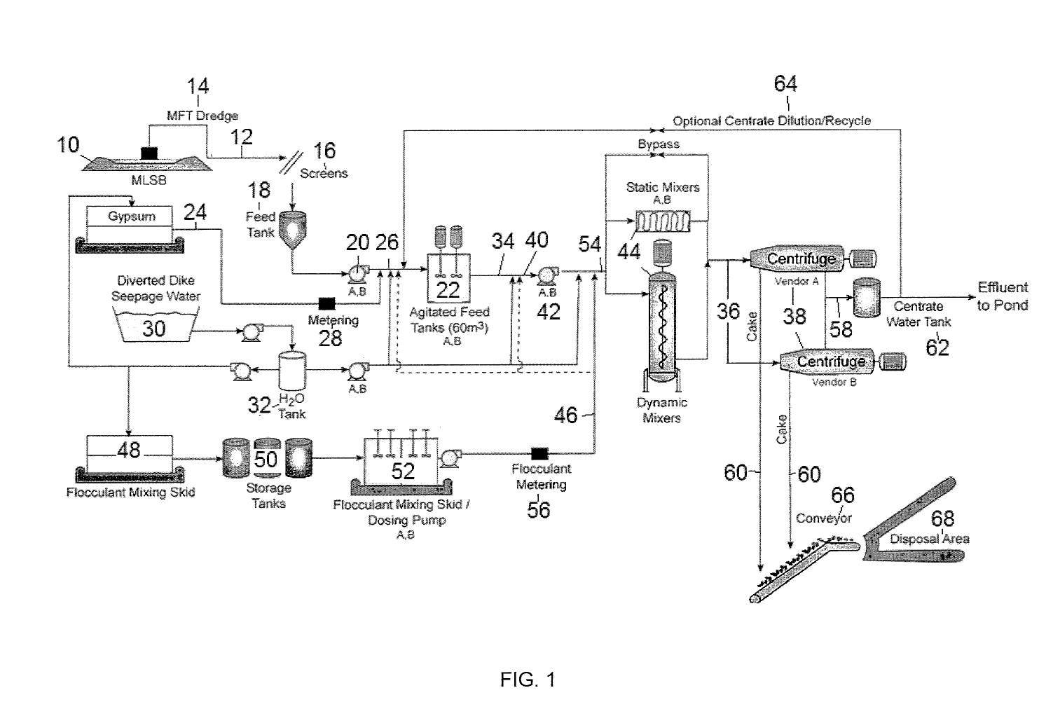

FIG. 1 is a flow diagram of an embodiment of a centrifugation process useful in the present invention. In one embodiment, the tailings are primarily FFT obtained from tailings ponds. However, it should be understood that the fine tailings treated according the process of the present invention are not necessarily obtained from a tailings pond, and may also be obtained from ongoing oil sands extraction operations.

The tailings stream from bitumen extraction is typically transferred to a tailings pond 10 where the tailings stream separates into an upper water layer, a middle FFT layer, and a bottom layer of settled solids. The FFT layer 12 is removed from between the water layer and solids layer via a dredge 14 or floating barge having a submersible pump. In one embodiment, the FFT 12 has a solids content ranging from about 10 wt % to about 45 wt %. In another embodiment, the FFT 12 has a solids content ranging from about 30 wt % to about 45 wt %. In one embodiment, the FFT 12 has a solids content ranging from about 37 wt % to about 40 wt %. The FFT 12 is preferably undiluted. The FFT is passed through a screen 16 to remove any oversized materials. The screened FFT 12 is collected in a vessel such as a tank 18. In one embodiment the FFT 12 is then pumped via a pump 20 from the tank 18 into an agitated feed tank 22 comprising a tank body and blades. In another embodiment FFT is pumped to a simple surge tank, and in yet another embodiment FFT is pumped directly to the centrifuge.

A coagulant 24 is introduced into the in-line flow of FFT prior to entering the agitated feed tank 22. In one embodiment, coagulant 24 is introduced into the in-line flow of FFT prior to entering the centrifuge 38. As used herein, the term “coagulant” refers to a reagent which neutralizes repulsive electrical charges surrounding particles to destabilize suspended solids and to cause the solids to agglomerate. Suitable coagulants include, but are not limited to, gypsum, lime, alum, polyacrylamide, or any combination thereof. In one embodiment, the coagulant comprises gypsum or lime. As used herein, the term “in-line flow” means a flow contained within a continuous fluid transportation line such as a pipe or another fluid transport structure which preferably has an enclosed tubular construction. Sufficient coagulant 24 is added at line 26 to initiate neutralization. The dosage of the coagulant 24 is controlled by a metering pump 28. In one embodiment, the dosage of the coagulant 24 ranges from about 300 grams to about 1,500 grams per tonne of solids in the FFT.

Dilution water 30 is required to disperse the coagulant 24 into the forward flow of the FFT 12 and to minimize the risk of total coagulation which would entrap the solids within the line 26. The dilution water 30 is introduced into the in-line flow of the FFT at line 26 prior to entering the agitated feed tank 22. The source of water 30 is preferably any low solids content process affected water. The FFT 12 and diluted coagulant 24 are blended together within the agitated feed tank 22, or in the pipeline when no feed tank is used. Agitation is conducted for a sufficient duration in order to allow the coagulant 24 to dissociate from the water 30 and agglomerate the FFT 12. In one embodiment, the duration is at least about five minutes.

The agitated FFT 34 is then diluted with water 30. The water 30 is introduced into the in-line flow of the agitated FFT 34 prior to entering a mixer 44. As previously mentioned, the source of water 30 is preferably any low solids content process affected water. Sufficient water 30 is added to achieve a centrifuge feed 36 having a solids content preferably in the range of about 18 wt % to about 36 wt %, preferably greater than about 30 wt %. Dilution provides a consistent feed 36 to the centrifuge 38 to ensure stable machine operation. In one embodiment, the diluted FFT 40 is pumped via a pump 42 from the agitated feed tank 22 into the mixer 44. In another embodiment FFT is piped directly to the mixer 44.

Additional water 30 and a flocculant 46 are introduced into the in-line flow of the diluted FFT 40 at a line 54 prior to entering the mixer 44. As used herein, the term “flocculant” refers to a reagent which bridges the neutralized or coagulated particles into larger agglomerates, resulting in more efficient settling. Flocculants useful in the present invention are generally anionic, nonionic, cationic or amphoteric polymers, which may be naturally occurring or synthetic, having relatively high molecular weights. Preferably, the polymeric flocculants are characterized by molecular weights ranging between about 1,000 kD to about 50,000 kD. Suitable natural polymeric flocculants may be polysaccharides such as dextran, starch or guar gum. Suitable synthetic polymeric flocculants include, but are not limited to, charged or uncharged polyacrylamides, for example, a high molecular weight polyacrylamide-sodium polyacrylate co-polymer.

Other useful polymeric flocculants can be made by the polymerization of (meth)acryamide, N-vinyl pyrrolidone, N-vinyl formamide, N,N dimethylacrylamide, N-vinyl acetamide, N-vinylpyridine, N-vinylimidazole, isopropyl acrylamide and polyethylene glycol methacrylate, and one or more anionic monomer(s) such as acrylic acid, methacrylic acid, 2-acrylamido-2-methylpropane sulphonic acid (ATBS) and salts thereof, or one or more cationic monomer(s) such as dimethylaminoethyl acrylate (ADAME), dimethylaminoethyl methacrylate (MADAME), dimethydiallylammonium chloride (DADMAC), acrylamido propyltrimethyl ammonium chloride (APTAC) and/or methacrylamido propyltrimethyl ammonium chloride (MAPTAC).

In one embodiment, the flocculant 46 comprises an aqueous solution of an anionic polyacrylamide. The anionic polyacrylamide preferably has a relatively high molecular weight (about 10,000 kD or higher) and medium charge density (about 20-35% anionicity), for example, a high molecular weight polyacrylamide-sodium polyacrylate co-polymer. The preferred flocculant may be selected according to the FFT composition and process conditions.

The flocculant 46 is supplied from a flocculant make up system for preparing, hydrating and dosing of the flocculant 46. Flocculant make-up systems are well known in the art, and typically include a polymer preparation skid 48, one or more storage tanks 50, and a dosing pump 52. The dosage of flocculant 46 is controlled by a metering pump 56, In one embodiment, the dosage of flocculant 46 ranges from about 400 grams to about 1,500 grams per tonne of solids in the FFT. In one embodiment, the flocculant is in the form of a 0.4% solution.

The additional water 30 is provided to disperse the flocculant 46 into the forward flow of the diluted FFT 40 and to minimize the risk of total flocculation which would entrap the solids within the line 54. When the flocculent 46 contacts the diluted FFT 40, it starts to react to form flocs formed of multiple chain structures and FFT minerals. The diluted FFT 40 and diluted flocculant 46 are further combined within the mixer 44. Since flocculated material is shear-sensitive, it must be mixed in a manner so as to avoid overshearing. Over-shearing is a condition in which additional energy has been input into the flocculated FFT, resulting in release and re-suspension of the fines within the water. Suitable mixers 44 include, but are not limited to, T mixers, static mixers, dynamic mixers, and continuous-flow stirred-tank reactors. Preferably, the mixer 44 is a T mixer positioned before the feed tube (not shown) of the centrifuge 38. In one embodiment, diluted flocculant 46 may bypass the mixer (44) and be fed directly to the feed line of the centrifuge 38 for addition to the diluted FFT 40.

Flocculation produces a suitable feed 36 which can be dewatered in the centrifuge 38. The feed 36 is transferred to the centrifuge 38 for dewatering. In one embodiment, the centrifuge 38 is a solid bowl decanter centrifuge. Solid bowl decanter centrifuges are capable of dewatering materials which are too fine for effective dewatering by screen bowl centrifuges. Extraction of centrate 58 occurs in the cylindrical part of the bowl, while dewatering of solids by compression of the cake 60 takes place in the conical part of the bowl. Separation of the centrate 58 and cake 60 using a solid bowl decanter centrifuge may be optimally achieved using low beach angle, deep pool depths, high scroll differential speed, and high bowl speed rpm.

In one embodiment, the centrate 58 has a solids content of less than about 3 wt %. The centrate 58 may be collected into a tank 62 and either discharged back to the tailings pond 10, or diverted into a line 64 for recycling for flocculant make-up or feed dilution.

In one embodiment, the cake 60 has a solids content of at least about 50 wt %, typically, about 52 to 55% solids. The cake 60 may be collected and transported via a conveyor 66, pump or transport truck to a disposal area 68. Centrifuge cake is produced at with typical shear strength of 0.75 to 1.5 kPa. Thus, a tailings management deposit constructed only of fresh cake is too soft and not trafficable by light equipment. Thus, additional dewatering needs to occur before the centrifuge cake deposits can be reclaimed and are trafficable.

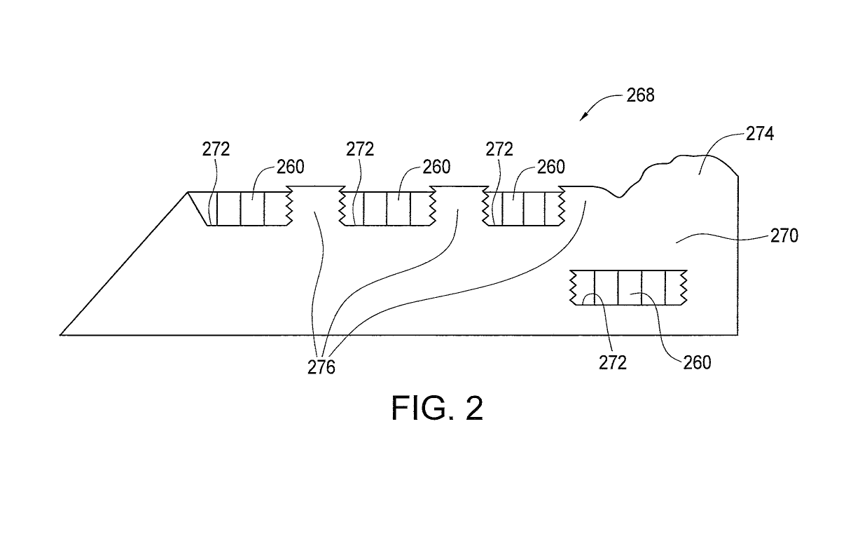

FIG. 2 is a schematic of one embodiment of a disposal area 268 for centrifuge cake 260 for enhanced dewatering and reclamation. Disposal area 268 comprises an overburden containment structure 270 having a plurality of containment trenches 272 for receiving centrifuge cakes 260 produced from the centrifugation of oil sands tailings. The overburden containment structure 270 may further comprise a plurality of ribs 276 for truck access. After a period of time, the trenches 272 can be covered with additional overburden to produce overburden cap 274. Such process is also referred to herein as an overburden poldering operation. Any water released, together with any environmental precipitation, can either drain naturally or with the aid of geo-drains and the like or can be pumped in order to maintain a dry surface.

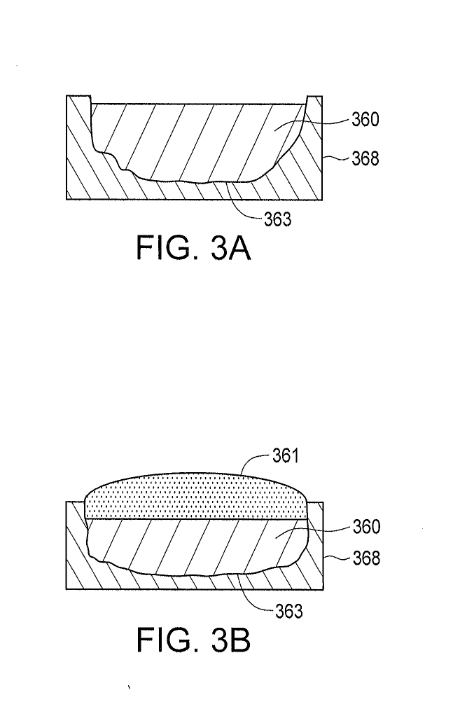

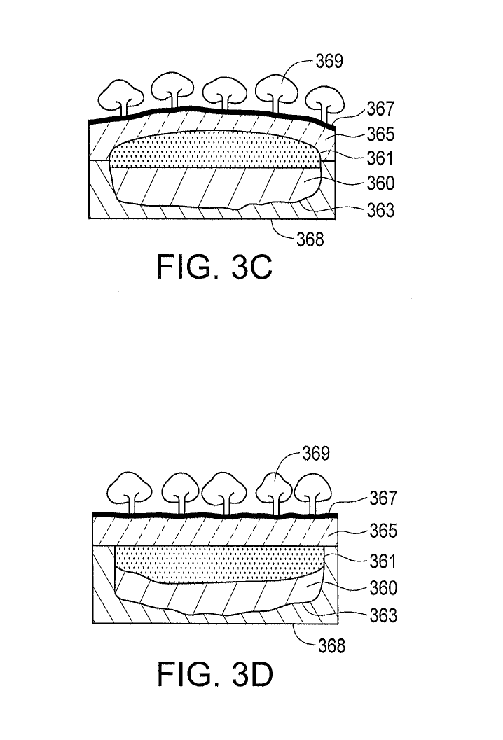

FIGS. 3A to 3D are schematics of another embodiment of a disposal area 368 for centrifuge cake 360 for enhanced dewatering and reclamation, which shows the progression of deep cake deposit. In FIG. 3A, disposal site 368 comprises a deep pit 363, e.g., a mined out oil sand pit, wherein the centrifuge cake 360 is deposited to fill a volume which will accommodate consolidation. Further dewatering/volume reduction of the centrifuge cake 360 occurs through self-weight consolidation and creep. FIG. 3B shows that in one embodiment a layer of petroleum coke 361 can be deposited on the centrifuge cake 360 (i.e., coke capping) to enhance dewatering rates. The petroleum coke will dewater to provide surcharge to the centrifuge cake. The surface of the petroleum coke can be further capped, typically with sand 365, to provide both a load to assist the consolidation of the upper part of the deposit and a substrate for top soil. The sand is then capped with top soil or reclamation material 367 and planted with trees 369 (and other vegetation), as shown in FIG. 3C. FIG. 3D shows that long term subsidence occurs, bringing elevation to final landform objectives.

Deep pits are generally favored as deposition sites for centrifuge cake where in-pit area and volume are available. Use of such deep pit deposits represents a very efficient land end-use with geotechnically secure containment. Consolidation time for deep pits deposits is affected by a number of factors, the most important of which are the character of the material, the rate of deposition per area and the overall depth of the deposit. It requires considerable technical effort to predict consolidation rates for design and to monitor performance through the operations and reclamation cycle.

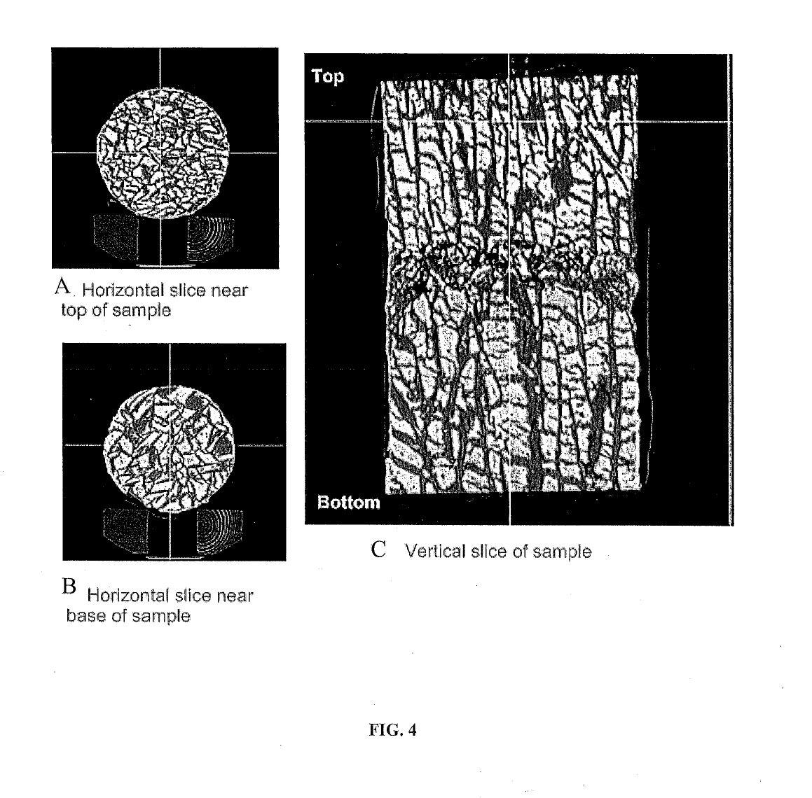

In another embodiment, accelerated dewatering of centrifuge cake deposits may be enhanced by freezing and thawing the deposits. Freezing and thawing the deposits causes the water to segregate from the cake, thereby maximizing runoff. The freezing of the deposits results in the formation of ice crystals as shown in FIG. 4. The ice crystals form capillaries within the centrifuge soil (cake) which allows water to drain from the soils when thawed. Drainage is essential to the densification of the centrifuge cake. As previously mentioned, it was discovered that frost penetration depth is increased by actively clearing snow during the winter using blowers, large fans and street sweepers. It was also discovered that repeatedly track-packing centrifuge cake deposits with dozers will also increase frost thickness.

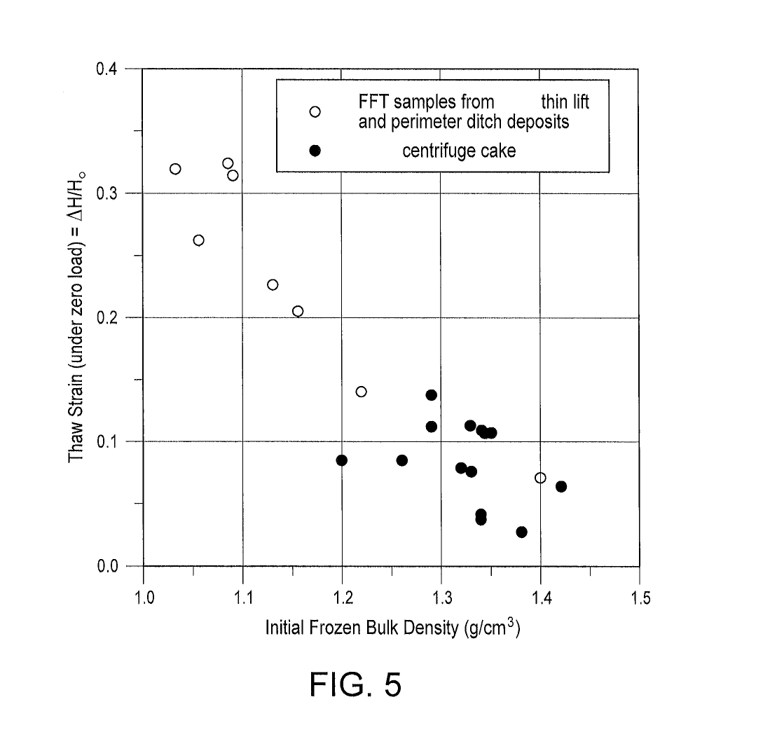

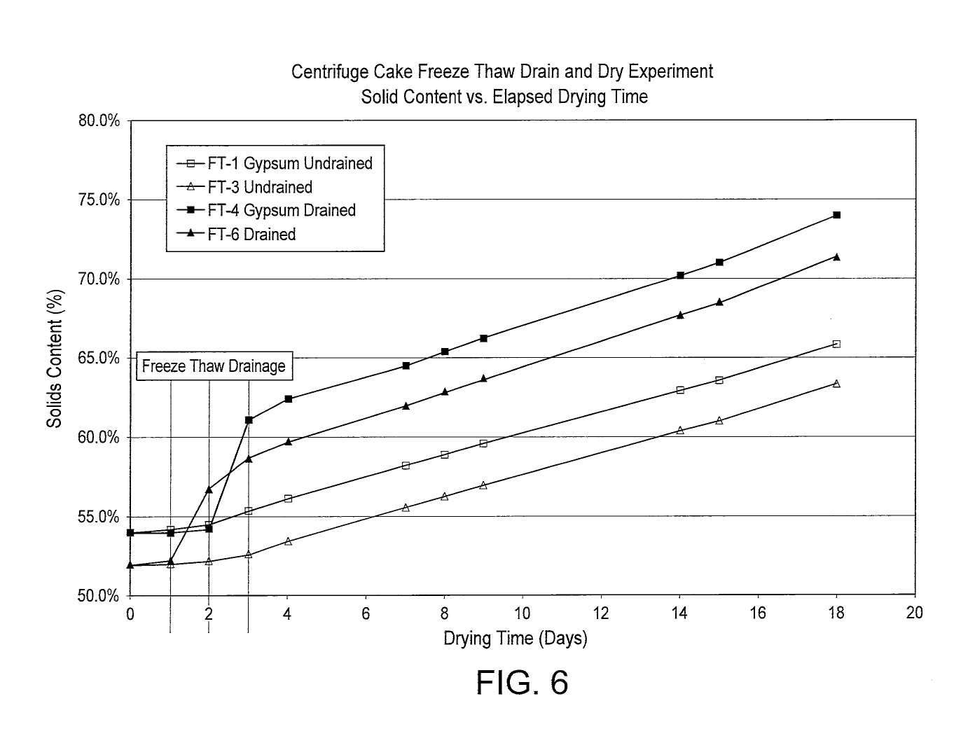

The impact of freeze thaw was investigated in frozen core samples recovered from centrifuge cake deposits. FIG. 5 shows that the measured thaw strains (4 to 14 percent) of the centrifuged FFT are consistently smaller than the observed sample ice contents (approximately 20 to 40 percent from visual inspection of the CT scans of the frozen cores). The sample apparatus did not allow vertical or lateral drainage and only a few of the test samples showed any water accumulation at the top of the thawed sample. This behavior is different from natural soils where the solids settle readily when thawed (e.g., Stephani et al., 2010). This suggests that under zero loading and undrained conditions, the frozen-thawed centrifuge cake microstructure is such that it can “absorb” melt water that does not readily drain away.

The impact of freeze, thaw, drainage and evaporative drying was further investigated at the lab scale. Samples of gypsum treated and untreated centrifuge cake samples were frozen and thawed under drained and undrained conditions. Five litre plastic pails were filled with centrifuge cake and allowed to freeze outside at −35 C for 48 hrs. The drained samples had holes in the bottom of the pails to allow water to drain out. The frozen cake samples were brought back inside and allowed to thaw at room temperature. The samples with drainage had an immediate 16% volume reduction from the original unfrozen volume upon thawing while the undrained samples had only a 5% volume reduction.

FIG. 8 presents the results of freeze-thaw evaporative drying experiments. For the drained samples, a rapid 5 to 7% increase in solids content occurs immediately on thawing. There was some volume change in the undrained samples but all water was still contained within the pail so no change in density was measured. A measurement of the undrained sample indicted that the surface dropped about 8 mm in spots and approximately 5 mm of free water was present. This was estimated to be approximately a 4.7% decrease in volume. The building humidity is set to 20% in the winter so evaporation was constant in the lab which is evident by the parallel lines of density increase during the evaporative drying phase. The centrifuge cake samples that were allowed to drain finished at a higher solids content than samples with no drainage. The gypsum treated samples increased in solids content slightly more (2%) than the untreated for the drained samples but there was no difference for the undrained.

From the foregoing description, one skilled in the art can easily ascertain the essential characteristics of this invention, and without departing from the spirit and scope thereof, can make various changes and modifications of the invention to adapt it to various usages and conditions. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

### REFERENCES

Stephani, E., Fortier, D., and Shur, Y., 2010. A cryofacies approach to describe ground ice in permafrost for engineering applications—Case study of a road test site on the Alaska Highway (Beaver Creek, Yukon, Canada), Joint 63rd Canadian Geotechnical Conference & 6th Canadian Permafrost Conference, Sep. 12-16, 2010, Calgary, Canada.

We claim:

1. A process for the consolidation, dewatering and disposal of oil sands tailings, comprising:
(a) optionally diluting the tailings with sufficient water to yield a tailings feed having a solids content in the range of about 18 wt % to about 36 wt %;
(b) adding one or both of a coagulant and a flocculant to the tailings feed to form a centrifuge feed;
(c) centrifuging the centrifuge feed to produce a centrifuge cake having a solids content of at least about 50% and a centrate having a solids content of less than about 3 wt %; and
(d) depositing the centrifuge cake into an overburden containment structure comprised of oil sand overburden, said overburden containment structure comprising a least one trench for holding the centrifuge cake.

2. The process as claimed in claim 1, whereby when the at least one trench is filled with centrifuge cake, additional mined overburden can be placed on top of the at least one trench to form an overburden cap.

3. The process as claimed in claim 1, further comprising:
(e) draining the water released from the centrifuge cake together with any environmental precipitation.

4. A process for the consolidation, dewatering and disposal of oil sands tailings, comprising:
(a) optionally diluting the tailings with sufficient water to yield a tailings feed having a solids content in the range of about 18 wt % to about 36 wt %;
(b) adding one or both of a coagulant and a flocculant to the tailings feed to form a centrifuge feed;
(c) centrifuging the centrifuge feed to produce a centrifuge cake having a solids content of at least about 50% and a centrate having a solids content of less than about 3 wt %; and
(d) depositing the centrifuge cake into a deep disposal site for additional dewatering of the centrifuge cake through self-weight consolidation and creep.

5. The process as claimed in claim 4, wherein the deep disposal site comprises a mined out or excavated mine pit.

6. The process as claimed in claim 4, further comprising:
(e) adding a sand layer over the deposited centrifuge cake to enhance dewatering rates.

7. The process as claimed in claim 4, further comprising:
(e) adding geo-drains to the deep disposal site to enhance dewatering rates.

8. The process as claimed in claim 4, further comprising:
(e) draining released water and environmental precipitation from the deep disposal site.

9. The process as claimed in claim 4, further comprising:
(e) adding a petroleum coke layer over the deposited centrifuge cake to enhance dewatering rates.

10. The process of claim 9, further comprising:
(f) adding a sand layer over the petroleum coke layer.

11. The process of claim 10, further comprising
(g) adding a top soil layer over the sand layer.

12. The process as claimed in claim 11, further comprising:
(h) planting vegetation including trees in the top soil.

13. The process of claim 1, wherein in step (a), the solids content is greater than about 30 wt %.

14. The process of claim 1, wherein in step (b), the tailings feed and flocculant are combined within a mixer.

15. The process of claim 14, wherein the flocculant is added in-line prior to entering the mixer.

16. The process of claim 15, further comprising diluting the flocculant.

17. The process of claim 16, wherein the dosage of flocculant ranges from about 400 grams to about 1,500 grams per tonne of solids in the tailings.

18. The process of claim 17, wherein the flocculant is the form of a 0.2-0.4% solution.

19. The process of claim 18, wherein the flocculant comprises a polyacrylamide anionic flocculant.

20. The process of claim 1, wherein in step (b), the flocculant is fed directly to the centrifuge.

21. The process of claim 1, wherein the centrifuge is a solid bowl decanter centrifuge.

22. The process of claim 1, wherein the tailings comprise fluid fine tailings.

23. The process of claim 1, wherein the deposited centrifuge cake is subjected to freeze-thaw cycles to enhance the dewatering of the centrifuge cake.

24. The process of claim 4, wherein in step (a), the solids content is greater than about 30 wt %.

25. The process of claim 4, wherein in step (b), the tailings feed and flocculant are combined within a mixer.

26. The process of claim 4, wherein in step (b), the flocculant is fed directly to the centrifuge.

27. The process of claim 4, wherein the centrifuge is a solid bowl decanter centrifuge.

28. The process of claim 4, wherein the tailings comprise fluid fine tailings.

29. The process of claim 4, wherein the deposited centrifuge cake is subjected to freeze-thaw cycles to enhance the dewatering of the centrifuge cake.
